(19) United States
(12) Patent Application Publication
(10) Pub. No.: US 2007/0171866 A1
(43) Pub. Date: Jul. 26, 2007

(54) Method for transmitting data inside a base station for a mobile radio system and corresponding base station

(76) Inventors: Peter Merz, Munchen (DE); Armin Splett, Ulm (DE)

Correspondence Address: STAAS & HALSEY LLP, SUITE 700, 1201 NEW YORK AVENUE, N.W., WASHINGTON, DC, 20005, US

(21) Appl. No.: 10/590,433

(22) PCT Filed: Jan. 3, 2005
(86) PCT No.: PCT/EP05/50006

§ 371 Date: Aug. 23, 2006

(30) Foreign Application Priority Data
Feb. 23, 2004 (EP) 04004076.8

(51) Int. Cl. H04Q 7/00

(52) U.S. Cl. 370/330

(57) ABSTRACT

Data IQ of a first mobile radio system are processed in the baseband unit BB of the base station BS, and are converted from or into the high-frequency range inside a high-frequency unit RF of the base station. The data IQ of the first mobile radio system are transmitted between the baseband unit BB and the high-frequency unit RF via an interface IC. Data IP to be transmitted of a second mobile radio system are, before a processing in the baseband, and/or received data IP of the second mobile radio system are, after a processing, also transmitted via the interface IC.

### CROSS REFERENCE TO RELATED APPLICATIONS

This application is based on and hereby claims priority to European Application No. EP04004076 filed on Feb. 23, 2006, the contents of which are hereby incorporated by reference.

### BACKGROUND

A method for transmitting data inside a base station of a mobile radio system and a corresponding base station are described.

In mobile radio systems, users of the mobile radio system communicate via radio waves. A plurality of mobile radio systems are known, for example for the second mobile radio generation GSM (Global System of Mobile Communication) or IS-95 and for the third mobile radio generation UMTS-FDD (Universal Mobile Telecommunication System—Frequency Division Duplex). Furthermore, mobile radio systems may be produced which are designed according to one of the so-called WLAN—(Wireless Local Area Network) or WMAN (Wireless Metropolitan Area Network) standards, such as for example the 802.x standards.

The radio access points of mobile radio systems, by means of which users communicate via the air interface, are frequently also designated as base stations. A plurality of companies have, together with Siemens, defined an interface inside such base stations, which is firstly intended to be used for UMTS-FDD and subsequently also for other standards. This interface is known by the designation Common Public Radio Interface (CPRI). CPRI connects the so-called radio equipment control portion of a base station with its so-called radio equipment portion. The radio equipment control portion includes, amongst other things, the baseband processing of the signals to be transmitted and/or the received signals, whilst in the radio equipment portion, signals to be transmitted are converted into the high frequency band and/or received signals are converted into baseband.

In order to save costs in network planning and in installation, it may be useful to provide base stations and/or radio access points of different mobile radio systems at the same location.

### SUMMARY

In transmitting data inside a base station of a first mobile radio system, data of the first mobile radio system are processed in baseband in a baseband unit of the base station and converted in a high frequency unit of the base station from and/or into the high frequency range, that the data of the first mobile radio system are transmitted between the baseband unit and the high frequency unit via an interface and that data to be transmitted of a second mobile radio system, before processing in baseband, and/or received data of the second mobile radio system, after processing in baseband, are also transmitted via the interface.

Whilst data to be transmitted of the first mobile radio system are therefore processed in baseband before their transmission via the interface and only converted into the high frequency range after transmission via the interface, data to be transmitted of the second mobile radio system are transmitted via the interface, even before baseband processing. Similarly, therefore, the baseband processing for received data of the first mobile radio system is only carried out after transmission via the interface, whilst the baseband processing for received data of the second mobile radio system is already carried out before transmission via the interface.

This means that no separate interface has to be provided for the transmission of the data of the second mobile radio system from the location of the high frequency unit to the location of the baseband unit of the base station of the first mobile radio system and in the reverse direction. Thus, the requirement for an additional connection for transmitting the data of the second mobile radio system is dispensed with. This is particularly advantageous when the distance between the high frequency unit and the baseband unit is considerable, such as for example if the baseband unit is arranged in the cellar of a building and the high frequency unit on the roof of the building.

Therefore, an interface between the baseband unit and the high frequency unit, provided in any case for the base station of the first mobile radio system, is used also for the transmission of data of the second mobile radio system, without costly adaptations to the design of the base station of the first mobile radio system having to be carried out.

According to a development, the data of the second mobile radio system are input and/or output data of a radio access point of the second mobile radio system.

The two mobile radio systems may be any kind of mobile radio systems, in which a communication with mobile users is carried out via radio waves. At least one of the two mobile radio systems may, for example, be of cellular construction, i.e. include a plurality of cells with at least one base station and/or one radio access point, which serves to supply the respective cells.

According to an embodiment, the interface between the baseband unit and the high frequency unit is a serial interface, via which the data of the two mobile radio systems are transmitted in time-division multiplexing. According to a preferred embodiment, the serial interface is an interface according to the aforementioned CPRI standard. In this connection, each version of the CPRI standard (the current version is Version 1.0) is considered, as are future versions.

According to an embodiment, the data of the first mobile radio system are to be assigned to the physical layer and the data of the second mobile radio system to a higher layer of a reference model, in particular of the ISO-OSI (International Standards Organization-Open System Interconnect) reference model.

According to a development, the base station of the first mobile radio system and the radio access point of the second mobile radio system transmit and/or receive signals to be transmitted by means of a common transmitting and/or receiving antenna. As a result, the necessity of separate antennae is avoided.

Irrespective of whether common transmitting or receiving antennae are used, preferably the radio access point of the second mobile radio system and the high frequency unit of the base station of the first mobile radio system are structurally integrated in a common unit. However, both may also be constructed separately from one another.

The base station for the first mobile radio system preferably includes means and/or units which aid the performance of the method.

### BRIEF DESCRIPTION OF THE DRAWINGS

These and other objects and advantages of the present will become more apparent and more readily appreciated from the following description of the preferred embodiments, taken in conjunction with the accompanying drawings of which:

FIG. 1 is a block diagram of a first embodiment; and

FIG. 2 is a block diagram of a second embodiment.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

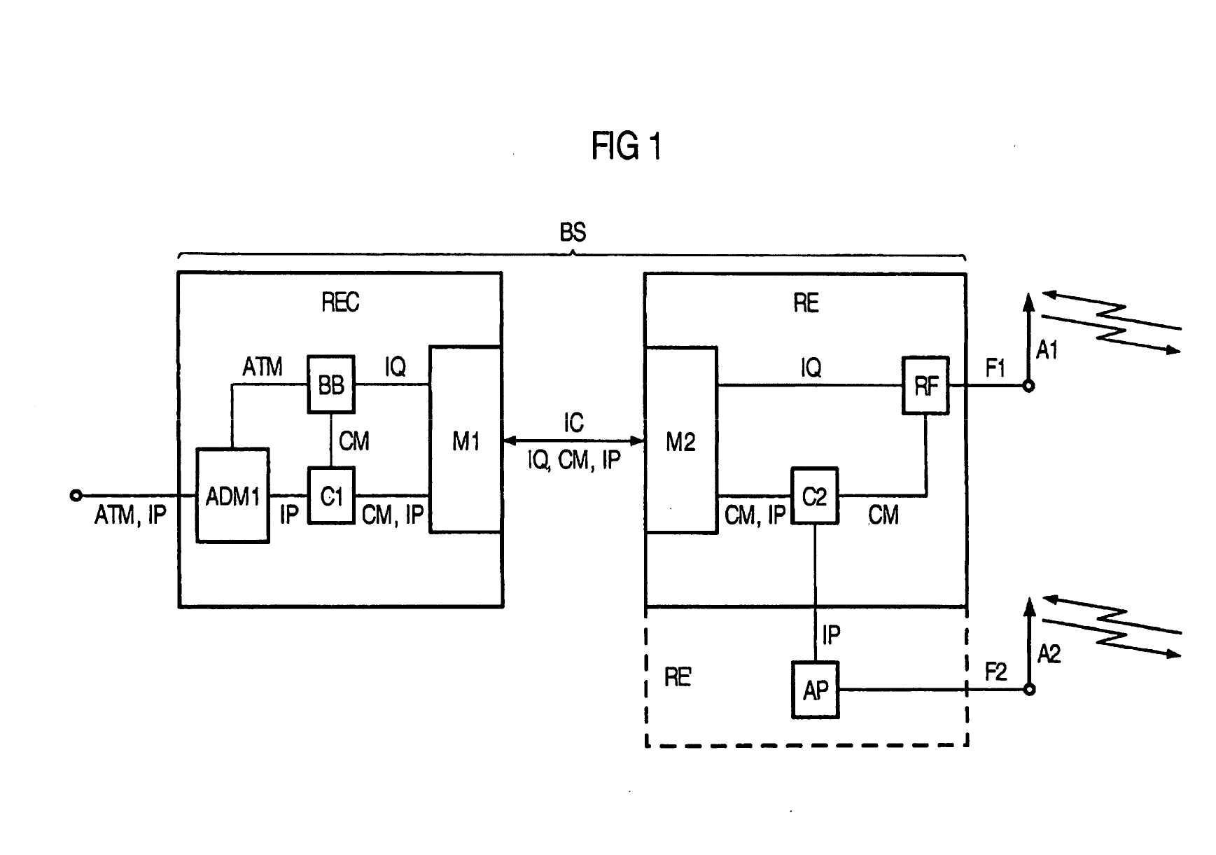

FIG. 1 shows a base station BS of a first mobile radio system according to the UMTS-FDD-standard and a radio access point AP of a second mobile radio system according to a WLAN or WMAN standard, for example 802.11 or 802.16. In other embodiments, the base station BS and the radio access point AP, however, may also be assigned to any other mobile radio systems, for example both may be assigned to mobile radio systems which correspond to the same standard but are operated by different operating companies.

The base station BS in FIG. 1 includes a first unit REC (Radio Equipment Control) and a second unit RE (Radio Equipment), which are connected to one another via an interface IC according to the CPRI-standard. The control and management of the base station is carried out in the first unit REC by a first processor C1 which generates corresponding control signals CM for controlling further functional units inside the base station BS. The control of the transmitting power with which signals to be transmitted are to be emitted via the second unit RE, is carried out via the control signals CM, for example. The second unit RE includes a second processor C2 for processing control signals CM transmitted by the first processor C1 and for corresponding control of the high frequency unit RF. At least one portion of the control signals CM is therefore transmitted via the interface IC to the second unit RE and on to the second processor C2. Even in the reverse transmission direction, control signals CM are transmitted from the second processor C2 to the first processor C1. In this connection, these signals are control signals for automatic gain control and for received signal strength, for example.

The control signals CM of the first processor C1 enter, via an interface IC, the second processor C2 inside the second unit RE which undertakes an evaluation of the control signals CM and controls the high frequency unit RF in an appropriate manner.

The first unit REC of the base station BS includes a baseband unit BB for processing data IQ of the first mobile radio system in baseband. The baseband unit BB carries out, amongst other things, channel coding, interleaving, spreading and scrambling of data to be transmitted of the first mobile radio system. Similarly, the baseband unit BB carries out channel decoding, de-interleaving, de-spreading and de-scrambling of received data of the first mobile radio system.

In the second unit RE of the base station BS, a high frequency unit RF is located, by which the data IQ, which have previously been generated by the baseband unit BB and transmitted via the interface IC, are converted to digital/analog, converted into the high frequency range and then amplified in power and emitted as radio signals F1 via a first antenna A1. In the reverse transmission direction, radio signals F1 of the first mobile radio system received via the first antenna A1 undergo low noise amplification inside the high frequency unit RF, are converted from the high frequency range into baseband and then converted to analog/digital. The received data IQ are then transmitted via the interface IC to the baseband unit BB. After the baseband processing in the baseband unit BB, the received data of the first mobile radio system are fed as ATM-data packets ATM (in other embodiments they may also be IP-data packets or circuit switched data, for example) via a first add-drop-multiplexer ADM1 to an outlet of the base station BS, from where transmission to a base station controller and/or radio network controller (not shown in FIG. 1) is carried out. In the reverse transmission direction, ATM-data packets ATM from the base station controller enter the baseband unit BB of the base station BS via the first add-drop-multiplexer ADM1 and from there, after baseband processing, enter the high frequency unit RF inside the second unit RE of the base station BS, via the interface IC.

Data IP of the second mobile radio system, namely input and output data of the radio access point AP, are transmitted in addition to the baseband data IQ and the control signals CM, in time division multiplexing via the interface IC between the two units REC, RE of the base station BS. In this connection, the (user) data IQ of the first mobile radio system is transmitted according to the CPRI IQ protocol, whilst the control signals CM are transmitted by an HDLC (High Data Link Control) protocol or ethernet protocol and the data IP of the second mobile radio system are transmitted according to the ethernet protocol or HDLC protocol.

The data IP of the second mobile radio system have the format of IP (Internet Protocol) data packets. The radio access point AP has the same functionality as a conventional radio access point of the second mobile radio system under consideration, in this example the same as a conventional radio access point according to the 802.11 or 802.16 standard. The radio access point AP may, as shown in FIG. 1, be designed to be constructed separately from the second unit RE of the base station BS of the first mobile radio system. It is, however, also possible that the radio access point AP is structurally integrated into the second unit RE (corresponding to the second unit RE′ indicated by dotted lines in FIG. 1).

Both baseband processing of the data IP and their conversion from baseband into the high frequency range and/or vice versa is carried out in the radio access point AP of FIG. 1. Radio signals F2 of the second mobile radio system received via a second antenna A2, are fed to the radio access point AP, converted there into baseband and subjected to baseband processing. As output signals of the radio access point AP, the data IP are fed in the form of IP packets to the second processor C2 inside the second unit RE of the base station BS. In this exemplary embodiment, the second processor C2 has, namely, the additional functionality of a router for the data IP of the second mobile radio system between the interface IC and the radio access point AP and in the reverse direction (in other exemplary embodiments, this functionality of the second processor may also be separated from the other functions of the second processor by a further processor). The second processor C2 transmits the data IP of the radio access point AP via the interface IC to the first processor C1 inside the first unit REC. The first processor C1 then forwards the data IP of the radio access point AP to the first add-drop-multiplexer ADM1, which then delivers the data IP to a gateway (not shown) to the Internet. In the reverse transmission direction, data IP from the Internet to be transmitted by the radio access point AP firstly enter the first processor C1 via the first add-drop-multiplexer ADM1. From the first processor C1, data IP are transmitted via the interface IC to the second processor C2 and from there to the radio access point AP which, after baseband processing and conversion into the high frequency range, transmits the data as radio signals F2 to the second antenna A2, from where they are then emitted via the air.

The first unit REC and the second unit RE in FIG. 1 each have a multiplexer and a demultiplexer M1, M2. They are used to multiplex the (user) data IQ of the base station BS to be transmitted and/or received, the control signals CM of the first processor C1 and the data IP of the radio access point AP to the serial interface IC and/or to demultiplex the (user) data IQ of the base station BS to be transmitted and/or received, the control signals CM of the first processor C1 and the data IP of the radio access point AP from the serial interface IC to the corresponding lines inside the units REC, RE. Between the first processor C1 and the first multiplexer M1 and between the second multiplexer M2 and the second processor C2, the control signals CM and the data IP of the second mobile radio system are transmitted in time division multiplexing. Similarly, data ATM, IP is received at the input of the base station BS and, in the reverse transmission direction, data is also transmitted in time division multiplexing via a common line.

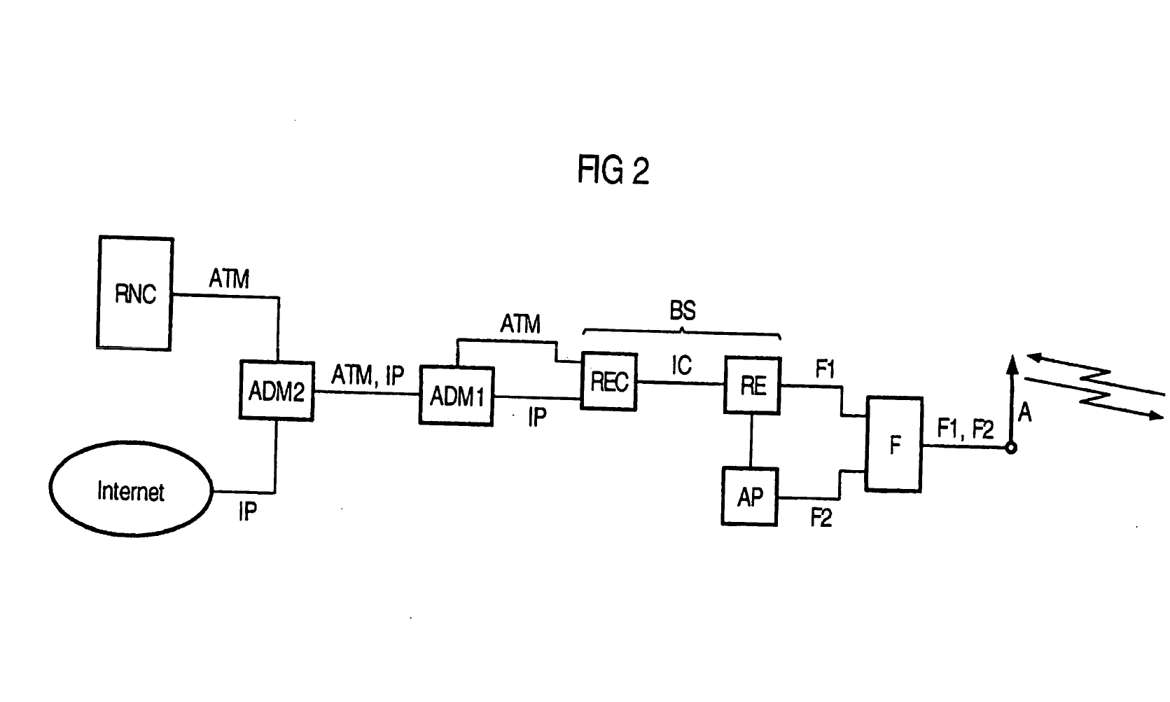

FIG. 2 shows a second exemplary embodiment, in which the base station BS and the radio access point AP (which, for example, may in turn be integrated into the second unit RE of the base station BS) transmit and receive their radio signals F1, F2 via a common antenna A. To this end, the radio signals F1, F2 are combined in a unit F and emitted via the antenna A and/or separated from one another in the reverse transmission direction by the unit F. The latter is easily carried out, in particular, when the radio signals F1, F2 are in different frequency bands. In contrast to the exemplary embodiment of FIG. 1, in FIG. 2 the first add-drop-multiplexer ADM1 at the input and/or output of the base station BS is not structurally integrated as a component thereof into the first unit REC of the base station BS, but designed separately therefrom. The data packets ATM, IP are transmitted from the first add-drop-multiplexer ADM1 by a connection (for example based on SDH (Synchronous Digital Hierarchy) or PDH) to a second add-drop-multiplexer ADM2, which demultiplexes the data packets ATM, IP received via the air interfaces and delivers the data packets ATM corresponding to the data IQ of the first mobile radio system to a base station controller RNC and delivers the data IP of the second mobile radio system to the Internet via a gateway. The data packets ATM, IP to be transmitted are multiplexed on the common line by the second ADM multiplexer ADM2 to the first add-drop-multiplexer ADM1.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-10. (canceled)

11. A method for transmitting data between a first unit and a second unit inside a base station of a first mobile radio system, comprising:
processing in baseband first mobile radio system data in a baseband unit of the first unit;
transmitting the first mobile radio system data, after processing in baseband, between the baseband unit of the first unit and a high frequency unit of the second unit via a serial interface;
converting, in the high frequency unit of the second unit, the first mobile radio system data at least one of from and into the high frequency range;
transmitting second mobile radio system data, before processing in baseband by the first unit, from the first unit via the interface to the second unit; and
processing in baseband and converting into the high frequency range in a radio access point, the second mobile radio system data transmitted via the interface.

12. The method as claimed in claim 11, further comprising:
receiving at the radio access point new second mobile radio system data;
converting in the radio access point the new second mobile radio system data from the high frequency range to baseband;
processing in baseband in the radio access point; and
transmitting the new second mobile radio system data via the interface from the radio access point to the first unit.

13. The method as claimed in claim 12, wherein the first mobile radio system data are transmitted via the serial interface using time division multiplexing.

14. The method as claimed in claim 11, wherein the radio access point of the second mobile radio system and the high frequency unit of the base station of the first mobile radio system are structurally integrated in a common unit or separate from one another, the second mobile radio system data being input data or output data of the radio access point.

15. The method as claimed in claim 14, further comprising using at least one of a common transmitting and a common receiving antenna by the base station of the first mobile radio system and the radio access point of the second mobile radio system.

16. The method as claimed in claim 15, wherein the first mobile radio system data are assigned to a physical layer and the second mobile radio system data are assigned to a higher layer of a reference model.

17. The method as claimed in claim 11, wherein the serial interface is operated according to the Common Public Radio Interface standard.

18. The method as claimed in claim 17, wherein the operation of one of the first and second mobile radio systems is cellular and the operation of the other of first and second mobile radio system is non-cellular.

19. A base station for a first mobile radio system, comprising:
a first unit including a baseband unit processing first mobile radio system data in baseband;
a second unit including a high frequency unit converting the first mobile radio system data from and/or into a high frequency range;
a serial interface, via which the data processed in baseband of the first mobile radio system are transmitted between the baseband unit of said first unit and the high frequency unit of said second unit;
means for transmitting second mobile radio system data from said first unit via the interface to said second unit before processing in baseband; and
a radio access point processing in baseband the second mobile radio system data transmitted via the interface and converting the second mobile radio system data into the high frequency range.

20. The base station as claimed in claim 19, wherein the high frequency unit and the radio access point are structurally integrated in a common unit.
